(19) United States
(12) Patent Application Publication
(10) Pub. No.: US 2005/0115901 A1
(43) Pub. Date: Jun. 2, 2005

(54) Preparation of waste water containing sodium chloride for use in chlor-alkali electrolysis

(76) Inventors: Juergen Heuser, Krefeld (DE); Werner Verhoeven, Kalmthout (BE); Domien Sluyts, Stabroek (BE)

Correspondence Address: BAYER MATERIAL SCIENCE LLC, 100 BAYER ROAD, PITTSBURGH, PA, 15205, US

(21) Appl. No.: 10/505,196

(22) PCT Filed: Feb. 10, 2003
(86) PCT No.: PCT/EP03/01282

(30) Foreign Application Priority Data
Feb. 22, 2002 (DE) 102 07 442.9

(51) Int. Cl. B01D 11/00

(52) U.S. Cl. 210/639; 210/749; 210/752; 95/263; 210/806

(57) ABSTRACT

The present invention relates to a process for the treatment of waste waters containing common salt, characterised in that, by a specific sequence of acidification, extraction, alkalisation and stripping steps, an aqueous common salt solution is obtained, which can be used directly in chlor-alkali electrolysis.

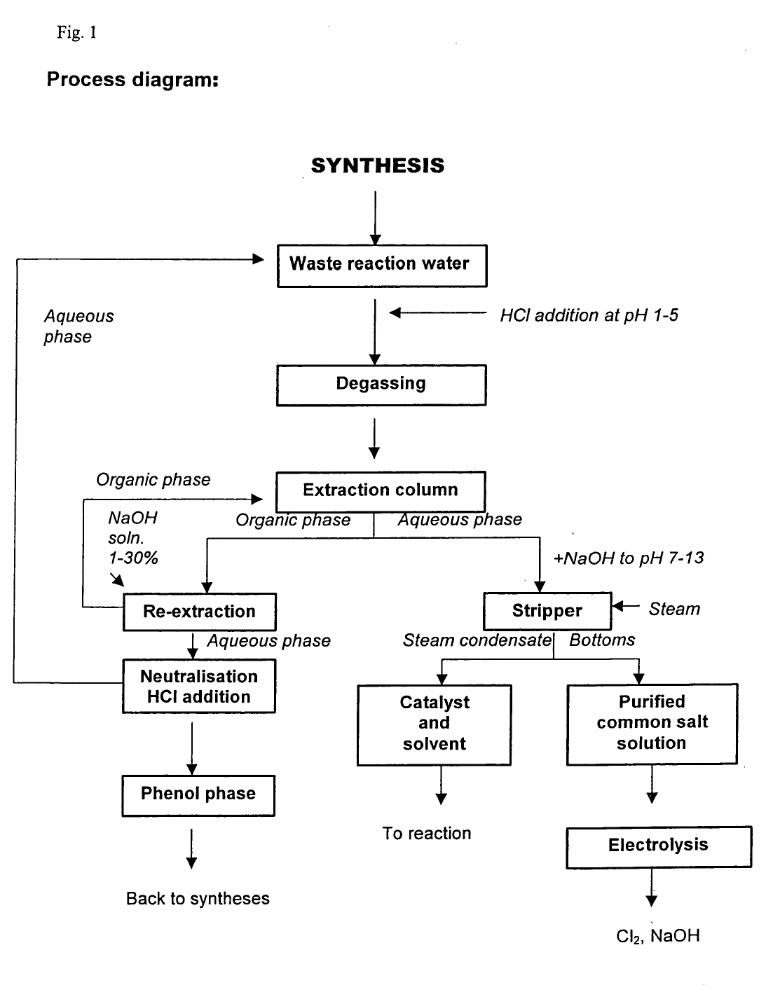

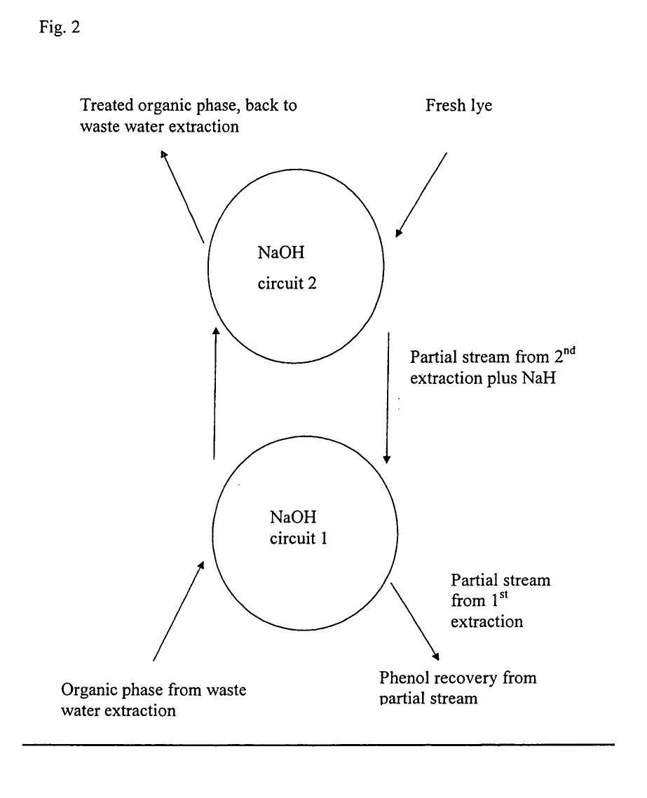

The present invention relates to a process for the treatment of waste waters containing common salt, characterised in that, by a specific sequence of acidification, extraction, alkalisation and stripping steps, an aqueous common salt solution is obtained, which can be used directly in chlor-alkali electrolysis.

Waste water containing common salt is obtained in many chemical processes, for example in the interfacial polycondensation process for the production of polycarbonate, or in the production of diphenyl carbonate, also by the interfacial polycondensation process, and many other chemical reactions in which common salt is formed directly or indirectly (cf. e.g. Schnell, “Chemistry and Physics of Polycarbonates”, Polymer Reviews, volume 9, Interscience Publishers, New York, London, Sydney 1964, p. 33 ff.).

To purify these waste waters, many methods are already known, such as e.g. activated carbon adsorption, distillation, extraction or ozonolysis. While it is true that the purified waste waters are then freed from most impurities, the waste water is nevertheless unsuitable for introduction into the environment owing to the common salt remaining. It is particularly problematic, for example, if the waste water is introduced into fresh water areas, which may still be used for the drinking water supply.

The question therefore arises of how these waste waters could better be eliminated. One possible solution would be to use these waste waters in chlor-alkali electrolysis. This would mean that, firstly, the environment would not be polluted with the salt and secondly, resources would be spared and thus raw material costs also saved.

For use in chlor-alkali electrolysis, however, only waste waters containing virtually exclusively chlorides as anions are suitable. Waste waters containing other anions and organic impurities must therefore be suitably treated beforehand.

Waste waters arising from polycarbonate or diaryl carbonate production, for example, also contain carbonates from phosgene hydrolysis in addition to common salt concentrations of 2 to 20%. In addition, apart from these inorganic salts, organic impurities are also present. Thus, residues of phenols or bisphenols, catalyst and solvent are still present. All these impurities would have to be reduced to a minimum to make use in chlor-alkali electrolysis possible.

It is known from EP A1 0 396 790 that dilute solutions that are formed can be treated by reactive extraction steps in such a way that a recyclable concentrate of certain components is obtained. However, no complete solution is disclosed for all solution streams that are formed. Also, nothing is said about a possible purification of a waste water stream containing common salt for use in chlor-alkali electrolysis.

Similar methods of treatment by means of physical extraction steps are also known to the person skilled in the art (cf. e.g. Ullmanns Encyclopedia of Industrial Chemistry, volume B3 page 6.3 to 6.6). Here, however, only dilute waste water streams are purified by extraction methods in such a way that the impurities are converted to more concentrated solutions, which can then be disposed of substantially more easily or cheaply.

It is known from DE-A 195 10 063 that waste waters from reactions containing common salt, e.g. as arising from the interfacial polycondensation processes for polycarbonate or diphenyl carbonate synthesis, can be treated by means of a reactive extraction after acidification in such a way that a solution suitable for introduction into the environment is obtained. It is also pointed out that this solution can be used in chlor-alkali electrolysis after suitable concentration. However, the process described there is not suitable for directly providing a solution that is suitable for use in chlor-alkali electrolysis. The load of organic residues still present after this process would also be concentrated during a concentration step and thus the solution would become unsuitable for chlor-alkali electrolysis. Even in the solution obtainable by this process without concentration, the load of organic residues would still be too high to use the solution in the membrane process for chlor-alkali electrolysis that is preferred today. Thus, DE-A 195 10 063 only discloses waste waters with a COD value of preferably <100 ppm, or at least 34 ppm in the examples. These waste waters would not be suitable for use in chlor-alkali electrolysis.

These known processes for the treatment of waste process waters therefore do not lead directly to a solution containing common salt that is suitable for use in chlor-alkali electrolysis, particularly by the membrane process. There is also no indication that it could be possible to achieve this with the aid of the technologies available up to the present.

On the basis of the prior art, therefore, the object arose of making available an improved treatment process for waste waters containing common salt, which leads to solutions containing common salt that are suitable for direct use in chlor-alkali electrolysis, and to as complete a use as possible of the partial streams with the smallest possible quantities of waste being obtained.

Surprisingly, it has now been found that waste process waters containing common salt can indeed be treated in such a way that the remaining common salt solution can be used directly in chlor-alkali electrolysis in that the waste process water
is acidified with HCI and degassed
then extracted with an organic solvent,
the aqueous phase is alkalised and
stripped with steam.

The process according to the invention achieves the following surprising advantages compared with the known processes of the prior art:
1. The salt solution obtained can be used directly in electrolysis; concentrating is not necessary. In the case of membrane electrolysis, salt purification is no longer necessary and the water can be recycled.
2. Salt and water quantities are reduced.
3. In the case of diphenyl carbonate production, the diphenyl carbonate residues present as an impurity in the waste water are converted to phenol during the extraction.
4. The extracted phenols can be reused as a raw material in the synthesis.
5. Only small quantities of waste water remain, which benefits the environment.
6. The process can also be operated without the use of components for reactive extraction.
7. The COD value achieved in the treated waste water is below 30 ppm and thus below the application limit of the COD process. The value cannot therefore be determined accurately but it is very low.
8. Content of phenolic impurities <1 ppm, of phenol <0.3 ppm, of bisphenol below the limit of detection, catalyst residues <1 ppm and organic solvent <1 ppm.

According to the process of the invention, the waste water from the reaction is first acidified with HCl, preferably with commercial 37% aqueous acid, to a pH of 1-5, preferably 3 to 4, especially preferably 3. The carbonates are thus converted to carbonic acid, which escapes as a gas. It is possible for the carbonic acid to be recovered in order to be converted to CO in a reformer. Phenolic anions are also converted to the corresponding free phenolic compounds.

The acidic solution is then brought into contact with an extracting agent. Apolar organic solvents, such as e.g. methylene chloride, chlorobenzene or a mixture of the two, MIBK (methyl isobutyl ketone) or ether, preferably methylene chloride, chlorobenzene, or a mixture of the two, can be used as the extracting agent. Alternatively, an insoluble base, preferably long-chained tertiary amines, such as e.g. alamine or triisooctylamine, particularly triisooctylamine, can be used as the reactive extracting agent, dissolved in inert apolar organic solvents, such as e.g. petroleum fractions, Shell-Sol AB, for example, being preferred. However, physical extraction with inert organic solvents is preferred. During this extraction, the phenolic compounds and other organic compounds are removed from the aqueous solution. This extraction takes place in several, preferably 4-10, steps. Mixer-settlers or extraction columns, preferably extraction columns, particularly preferably pulsed packed or sieve tray columns, can be used for this purpose, cf. e.g. Perry's Chemical Engineering Handbook, McGraw Hill, New York, 1999, 15-44 to 15-46. A ratio of organic phase to aqueous phase of 5:1 to 1:5, preferably 3:1 to 1:3, especially preferably 1:2, is aimed for.

The organic extraction phase obtained is then re-extracted with an aqueous sodium hydroxide solution in a concentration of 1 to 30%, preferably 5 to 20% NaOH. The alkaline-aqueous phase is used as extracting agent here in a significantly smaller quantity in order to achieve the highest possible phenolate concentrations in the alkaline-aqueous phase. A ratio of aqueous sodium hydroxide solution to organic phase of about 1:50 to 1:1000, preferably 1:400 to 1:1000, would suffice for the extraction with aqueous sodium hydroxide solution. The precise ratios, however, depend on the concentration of phenol in the organic phase to be worked up, as this is a reactive extraction in which approx. 1.1-1.5, preferably 1.2-1.3, particularly preferably 1.25 mol NaOH per mol phenol have to be used. Accordingly, the quantities have to be adapted to the concentration of phenol in the organic phase in each case. In order to achieve a miscible ratio, however, which does not exist with ratios of 1:50 to 1:1000, sodium hydroxide solution is circulated, as a result of which an actual ratio of circulated sodium hydroxide solution to organic phase of approx. 1:10 is achieved. A partial stream is removed from the circulated sodium hydroxide solution, which is replaced by fresh lye in each case. The ratio of removed partial stream to quantitative stream of the extracted organic phase now corresponds to the ratio mentioned above. The aqueous extract obtained here can be further treated to recover phenols.

A preferred method consists in carrying out the re-extraction with sodium hydroxide solution in two stages. In the first extraction step, extraction is performed as described above with an aqueous sodium hydroxide/phenolate solution, which is formed from the removed partial stream of the second extraction step, with the addition of extra NaOH to re-establish a concentration of 1 to 30%, preferably 5 to 20% NaOH. The partial stream forming at this stage is fed directly to phenol recovery and a corresponding quantity of sodium hydroxide solution from the second stage is fed back in as fresh lye, with the addition of extra NaOH to re-establish a concentration of 1 to 30%, preferably 5 to 20% NaOH. In the second extraction step, extraction is performed as described above with NaOH at a concentration of 1 to 30%, preferably 5 to 20% NaOH, the removed partial stream being replaced with fresh lye and this partial stream, with the addition of extra NaOH to re-establish a concentration of 1 to 30%, preferably 5 to 20% NaOH, is fed into the first stage as fresh extracting agent. As the removed partial stream from the first stage, a concentrated, aqueous-alkaline solution of the phenolates is obtained, from which two phases are formed by simple neutralisation with HCl, which can be separated in a simple separating vessel. In this way, an upper phase containing about 90% of the quantity of phenol is obtained, which can either be used again in a synthesis (e.g. DPC) or otherwise disposed of. The other phase consists of an aqueous common salt solution, which is slightly loaded with phenol and is fed back into the waste reaction water to be worked up.

The content of phenolic compounds in the organic phase is reduced to less than 1 ppm by this re-extraction. The organic phase freed from phenolic compounds in this way is fed back into the extraction of the waste reaction water as an extracting agent. The two-stage re-extraction can be designed e.g. in the form of a counter-current extraction. These re-extractions are preferably performed in a mixer-settler, e.g. as described in Perry's Chemical Engineering Handbook, McGraw Hill, New York, 1999, 15-22 to 15-29.

The extracted waste process water containing common salt, largely freed from phenolic and other organic compounds, is now alkalised with aqueous sodium hydroxide solution at any concentration, e.g. 1-50% NaOH, to a pH of 7-13, preferably 8-12, and stripped with steam at 1-4, preferably 2-3, particularly preferably 2.5 bar in a stripping column, cf. e.g. “azeotropic distillation” in Perry's Chemical Engineering Handbook, McGraw Hill, New York, 1999, 13-68 to 13-75. The quantity of steam to the quantity of solution to be stripped is in a ratio of 1-5, preferably 2-4, particularly preferably 3-3.5 to 100. In this step, both the catalyst and the residual solvent are removed. The top gases from the column therefore contain the catalyst and residual solvent, are condensed and can be fed back into the synthesis reaction. The bottom product is a pure common salt solution, which can now be used directly in chlor-alkali electrolysis.

The content of residual organics in the common salt solution treated in this way is <0.3, preferably <0.1 ppm, bisphenols and catalyst residues can no longer be detected and the residual content of organic solvents is <1 ppm, preferably <0.1 ppm.

All the steps in the process according to the invention are, unless expressly described otherwise, performed at temperatures below the lowest boiling point of the solvents used in each case and under atmospheric pressure. If necessary, however, the steps can also be performed at temperatures above these temperatures with pressure adjusted accordingly at the same time.

The following diagrams are intended to illustrate the process according to the invention, and the re-extraction explicitly, without, however, limiting the subject matter of the present invention.

### EXAMPLES

The following examples are intended to illustrate the present invention, but without restricting it:

### Example 1

A waste water from diphenyl carbonate production contains 200 ppm phenol, 30 ppm ethylpiperidine (EPP), 2 ppm diphenyl carbonate and 0.25% sodium carbonate.

98 kg of this waste water are brought to pH 4 with 2 kg of 37% hydrochloric acid and degassed. The residual concentration of carbonate ions is less than 200 ppm.

This solution is then extracted in an extraction column 5 metres in length, 0.05 metres in diameter and with 50 sieve plates using half the quantity (weight ratio) of methylene chloride.

The phenol concentration in the waste water after the extraction column is <200 ppb. The ratio of waste water to extracting agent (methylene chloride) is 2:1.

The resulting 50 kg of solvent, containing 400 ppm of phenol and 4-5 ppm of iphenyl carbonate, are then re-extracted with 250 g of 20% sodium hydroxide solution in 2 mixer-settlers in a counter-current process. The re-extract is neutralised with 241 g of 37% HCl. This solution separates, giving 19 g of organic phase (95% phenol) and 493 g of aqueous phase (1% phenol) at pH 4. These 493 g of aqueous phase are fed back into the fresh waste water at the beginning of the extraction. 50 kg of purified, water-containing solvent are fed back into the extraction.

100 kg of extracted waste reaction water from the extraction are then stripped in a stripper with 3.15 kg of steam at 2.5 bar. 1.03 kg of EPP and methylene chloride-containing water remain as top distillate, which can be fed back into the synthesis. As bottom distillate, 102.3 kg of an aqueous common salt solution remain, with 15-18% common salt and <1 ppm EPP and <1 ppm methylene chloride.

The COD is 28 ppm and can therefore no longer be reproducibly measured, as the sensitivity of the method is insufficient. The high NaCl content of the solution also leads to higher readings, so that the actual COD is significantly lower.

1-10. (canceled)

11. A process for purifying waste water containing one or more chlorides, residual acids, residual bases or residual solvents comprising:
a) acidifying the waste water,
b) contacting the waste water from step a) with an extracting agent in a manner such that an organic phase and an aqueous phase are generated,
c) adding an alkaline material to the aqueous phase generated in b) in an amount sufficient to cause that phase to have a pH of from 7 to 13, and
d) stripping the treated phase from step c) to obtain purified water.

12. The process of claim 11 in which the waste water to be treated was generated from an interfacial polycondensation process for production of a polycarbonate or a diphenyl carbonate.

13. The process of claim 11 in which carbonates are removed from the waste water to be treated prior to step a).

14. The process of claim 13 in which carbonate removal is achieved by acidifying and degassing the waste water.

15. The process of claim 11 in which organic compounds are removed by extraction with solvent.

16. The process of claim 11 in which the extracting agent used in step b) is a reactive extracting agent.

17. The process of claim 11 in which step b) is carried out in a column.

18. The process of claim 11 in which at least one phenolic compound is recovered by re-extracting the organic phase generated in step b) with an aqueous alkaline solution to generate a second organic phase and aqueous phase and neutralizing the second aqueous phase.

19. The process of claim 18 in which the re-extracting is conducted in one or more mixer-settlers.

20. The process of claim 18 in which the re-extracting is conducted as a countercurrent extraction.

21. The process of claim 18 in which the re-extracting is conducted in two-stages.
